(19) United States
(12) Patent Application Publication
(10) Pub. No.: US 2005/0073744 A1
(43) Pub. Date: Apr. 7, 2005

(54) Optical device

(75) Inventors: Nikolay Ivanovich Zheludev, Southampton (GB); Harry James Coles, Southampton (GB); Darren Marc Bagnall, Southampton (GB); Adrian Potts, Southampton (GB); Aris Papakostas, Southampton (GB)

Correspondence Address: SUGHRUE MION, PLLC, 401 Castro Street, Ste 220, Mountain View, CA, 94041-2007, US

(73) Assignee: University of Southhampton, Southampton (GB)

(21) Appl. No.: 10/500,265

(22) PCT Filed: Dec. 20, 2002
(86) PCT No.: PCT/GB02/05872

(30) Foreign Application Priority Data
Dec. 20, 2001 (GB) 0130513.5

(51) Int. Cl. G02B 5/30

(52) U.S. Cl. 359/489; 359/484

(57) ABSTRACT

An optical device, in one embodiment, is constituted by a substantially planar first layer, which in this example is a layer of gold, supported by a silicon substrate layer, in the form of a silicon wafer. The gold layer is formed with a pattern of solid shaped elements, in the form of (left-handed) gammadions. The gammadions have a size of between 700 nm and 4μ and are arranged in a tiled regular square pattern.

The ability of left-right asymmetrical (chiral) three-dimensional molecules to rotate the polarisation state of light, known as optical activity, is one of the most remarkable effects in optics The classical model of three-dimensional optical activity shows that for a medium to exhibit polarisation rotatory power, the constituent molecules should have no mirror symmetry. In addition, there must be coupling between different parts (chromophores) of the molecule. Such a medium, for example one consisting of randomly oriented helix-like molecules, will show opposite signs of polarisation azimuth rotation for the two mirror-symmetric (enantiomeric) forms of the constituting molecule. The general concept of chirality also exists in two-dimensions where a planar object is said to be chiral if it cannot be brought into congruence with its mirror image unless it is lifted from the plane.

Optical structures artificially engineered on a mesoscopic level such as photonic bandgap crystals, periodically altered dielectric materials, holey fibers, microsculptured films and composite media are attracting tremendous attention because of their potential importance in optoelectronic technologies. They are collectively known as “metamaterials”.

Layered metallic microstructures could play a special role in future technology, as they can be manufactured on a sub-optical wavelength scale using both well-established microelectronics technologies, and other non-traditional techniques. To date, however, research on layered chiral metalic microstuctures has been confined to theoretical analysis with only a few experiments having been performed In the microwave range of frequencies.

According to the present invention there is provided an optical device comprising:
a substantially planar layer of a first material, the layer being formed with a pattern of one or more shaped elements,
the or each shaped element and/or the pattern having no line of symmetry within the plane of the layer,
such that an optical signal incident on the device is reflected and/or transmitted and/or diffracted by the device, and at least one of the polarisation state, intensity and phase of the optical signal is changed as a result of its interaction with the device. The optical devices may comprise a plurality of substantially planar layers formed with a pattern of one or more shaped elements. The optical device preferably further comprises a substrate layer of a second material having different electromagnetic properties to the first material, the substrate layer supporting the layer of the first material. The first layer is preferably formed with a pattern comprising a plurality of shaped elements.

The or each shaped element is preferably a chiral shaped element, such as a gamma, a gammatta, a gammadion, an anti-gammadion, an S-shape, a spiral, a triskella, or a chiral split-ring. The chiral shaped element may alternatively be a bi-layered chiral shaped element.

Where a plurality of shaped elements are provided, the shaped elements may alternatively be non-chiral shaped elements, such as a cross having equal length arms, with the shaped elements being arranged in a pattern having planar chirality.

The shaped elements may be arranged or tiled in a regular pattern, an irregular pattern or a fractal pattern. The shaped elements may be arranged such that an incident optical signal is split into a plurality of diffracted beams, the diffracted beams converging towards a focal point, or diverging away from an effective focal point. The location of the focal point is preferably dependent on the polarisation state and/or wavelength of the incident optical signal, thereby forming a polarisation state and/or wavelength sensitive optical signal concentrator or de-concentrator. The shaped elements may alternatively be arranged such that an incident optical signal is split into a plurality of diffracted beams which converge or diverge to form a hologrammatic image, the convergence or divergence being dependent on the polarisation and/or wavelength of the incident optical signal.

The shaped elements may alternatively be arranged in one or more rings such that the optical device acts as a Fresnel lens on an incident optical signal.

The shaped elements may further alternatively or additionally be arranged to include hidden or secret coding of information, such that the interaction of an optical signal with the optical device causes the information to be applied to the optical signal in the form of an amplitude modulation or polarisation state modulation.

The or each shaped element preferably has a size of between one one-hundredth of the wavelength of an optical signal to be processed by the optical device and ten times the wavelength of an optical signal to be processed. The or each shaped element may comprise a solid shape formed in the first layer. The or each shaped element may alternatively comprise a hole formed in the first layer.

The first layer may comprise a layer of metal. The metal may be an elemental metal, such as gold or aluminium, or may be a metal alloy.

The first layer may alternatively comprise a layer of a semiconductor material. The semiconductor may be a polycrystalline semiconductor or an amorphous semiconductor, and may be doped or undoped. The first layer may be an epitaxial semiconductor layer. Any holes present within the first layer are preferably substantially filled with a dielectric material.

The first layer may further alternatively comprise a layer of a catalytic material, a dielectric material, an amorphous material or a glassy material. The first material may be superconducting.

The optical device may further comprise one or more ohmic contacts coupled to the first layer. The ohmic contacts are preferably optically transparent, and are most preferably fabricated from indium/tin oxide.

The first material may be ferromagnetic, ferroelectric, piezoelectric, electro-optic, magneto-optic, photo-acoustic or electro-acoustic to thereby allow at least one of the polarisation state, intensity, phase or direction of the transmitted, reflected and/or diffracted light to be changed. The first material may itself have planar chirality. The first material may contain particles, quasi-particles or excitations, such as plasmons, surface plasmon-polaritons, electrons, excitons or polaritons.

The substrate layer of a second material may comprise a layer of a crystalline material. Where the first layer comprises a layer of a semiconductor material, the substrate layer may comprise an epitaxial layer of the same semiconductor material as the first layer, or may comprise an epitaxial layer of a different semiconductor material to the first layer, to thereby form a heterojunction. Where-the semiconductor of the first layer is doped, the semiconductor of the substrate layer may be of the same doping concentration and/or type, or may be of a different doping concentration and/or type.

The second material is preferably optically transparent. The second material may have planar chirality. The second material may contain particles, quasi-particles or excitations, such as plasmons, surface plasmon-polaritons, electrons, excitons or polaritons.

The optical device may further comprise a third layer in the form of a layer of an electrically insulating material, a dielectric material, a piezoelectric material, a ferromagnetic material or a ferroelectric material. The third layer may be provided between the substrate layer and the first layer, or on top of the first layer. Where the shaped elements comprise bi-layered chiral shaped elements, the third layer may alternatively or additionally be provided between the layers of the bi-layered chiral shaped elements. The material of the third layer may contain particles, quasi-particles or excitations, such as plasmons, surface plasmon-polaritons, electrons, excitons or polaritons.

The optical device may alternatively or additionally comprise a layer of a surrounding material provided on top of the first layer. The surrounding layer may extend into one or more holes present in the first layer, preferably substantially filling the one or more holes. The surrounding material may have planar chirality. The surrounding material may contain particles, quasi-particles or excitations, such as plasmons, surface plasmon-polaritons, electrons, excitons or polaritons.

The optical device may further include a tunnel junction within a shaped element or between shaped elements. The tunnel junction may be a Josephson tunnel junction, a semiconductor tunnel junction, a Schottky tunnel junction or a metal/oxide/semiconductor tunnel junction.

The optical device may further comprise optical signal coupling means for coupling an incident optical signal to the device. The coupling means may comprise an optical waveguide, such as an optical fibre or a planar optical waveguide, or a near-field probe.

The optical device may be incorporated into a photonic bandgap crystal. The optical device may be provided at the end of an optical fibre or may be provided on a planar optical structure used for routing and/or processing optical signals.

The optical device may be incorporated into a photodetector, such as a pn-junction, to thereby modify at least one of the polarisation state, direction, intensity and phase of an optical signal to be detected by the photodetector.

The optical device may be incorporated into a photoemitter, such as a pn-junction, to thereby modify at least one of the polarisation state, direction, intensity and phase of an optical emitted by the photoemitter.

Specific embodiments of the invention will now be described by way of example only, with reference to the accompanying drawings, in which:

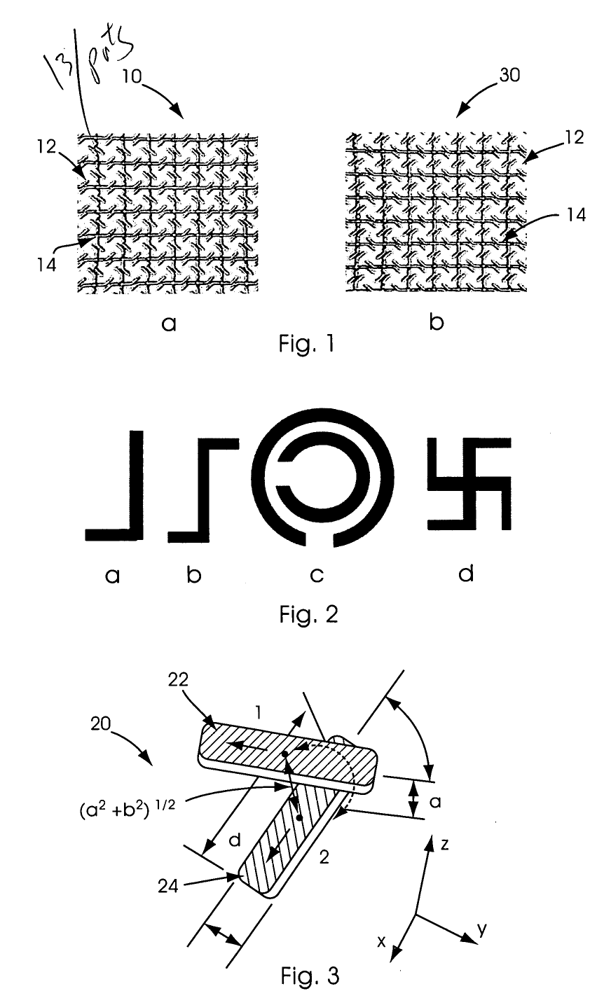

FIG. 1 shows optical micrographs (plan view) of optical devices according to (a) a first embodiment of the invention, and (b) a second embodiment of the invention;

FIG. 2 shows examples of some chiral shaped elements suitable for use in an optical device according to the present invention: (a) gamma; (b) gammatta; (c) chiral split-ring; and (d) gammadion;

FIG. 3 is a diagrammatic representation of a quasi planar bi-layered chiral shaped element suitable for use within an optical device according to the present invention;

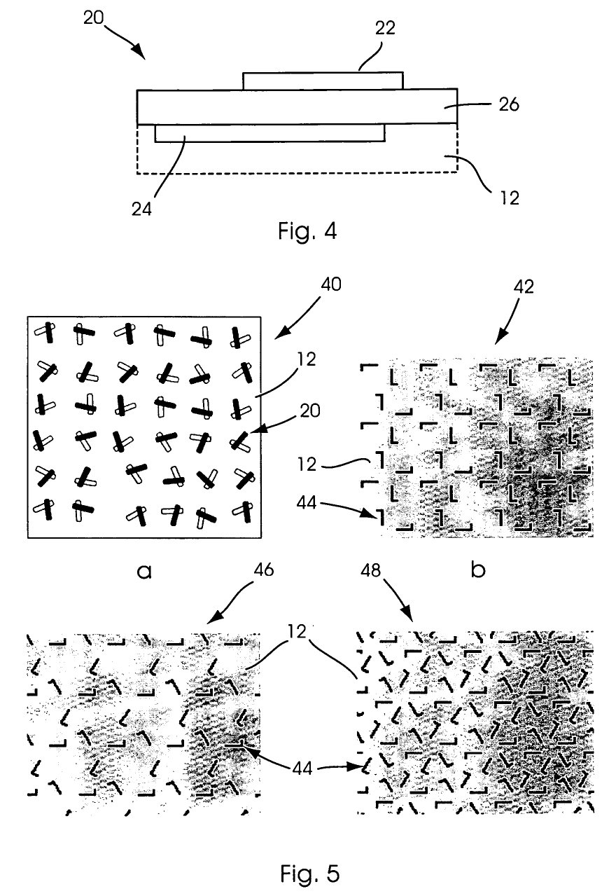

FIG. 4 is a diagrammatic cross-sectional representation of an alternative quasi planar bi-layered chiral shaped element;

FIG. 5(a) is a diagrammatic plan view of an optical device according to a third embodiment of the invention;

FIG. 5(b) is a diagrammatic plan view of an optical device according to a fourth embodiment of the invention;

FIG. 5(c) is a diagrammatic plan view of an optical device according to a fifth embodiment of the invention;

FIG. 5(d) is a diagrammatic plan view of an optical device according to a sixth embodiment of the invention;

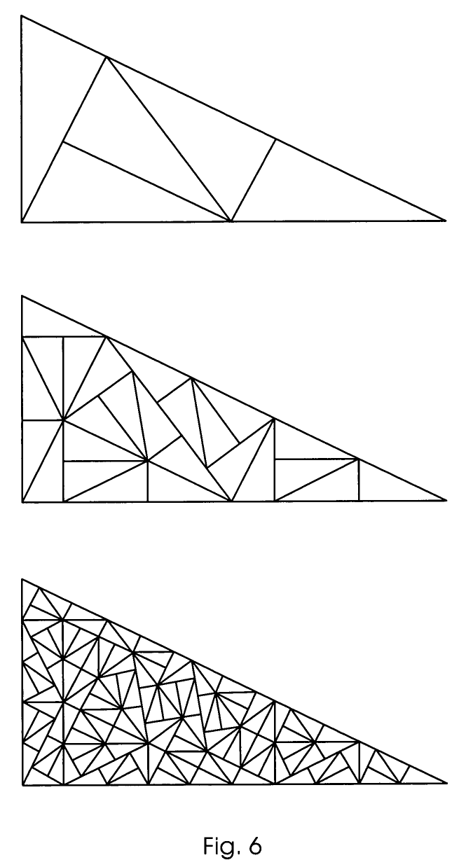

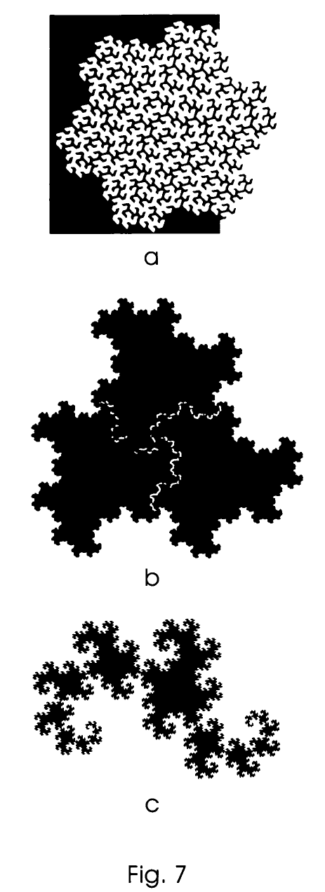

FIG. 6 shows three tiled chiral patterns in which the shaped elements of an optical device according to present the invention may be arranged;

FIG. 7 shows three fractal chiral patterns in which the shaped elements of an optical device according to present the invention may be arranged;

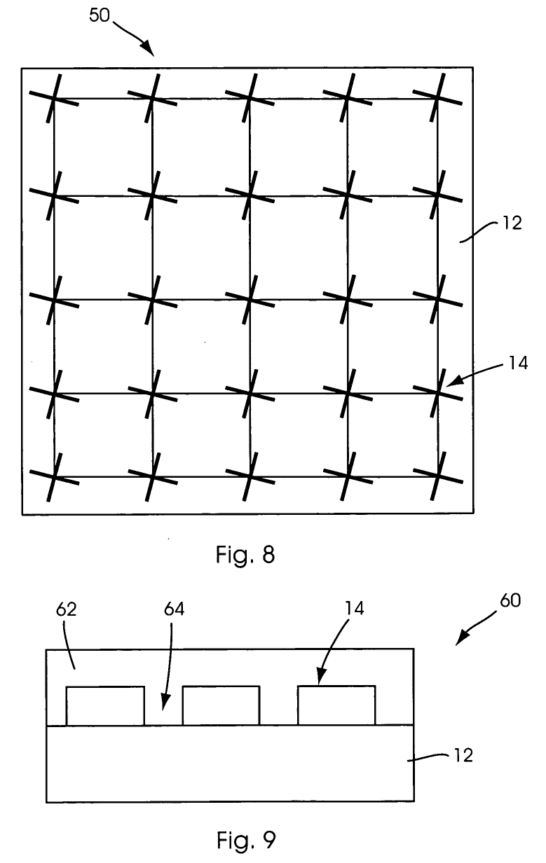

FIG. 8 is a diagrammatic plan view of an optical device according to a seventh embodiment of the invention;

FIG. 9 is a diagrammatic plan view of an optical device according to an eighth embodiment of the invention;

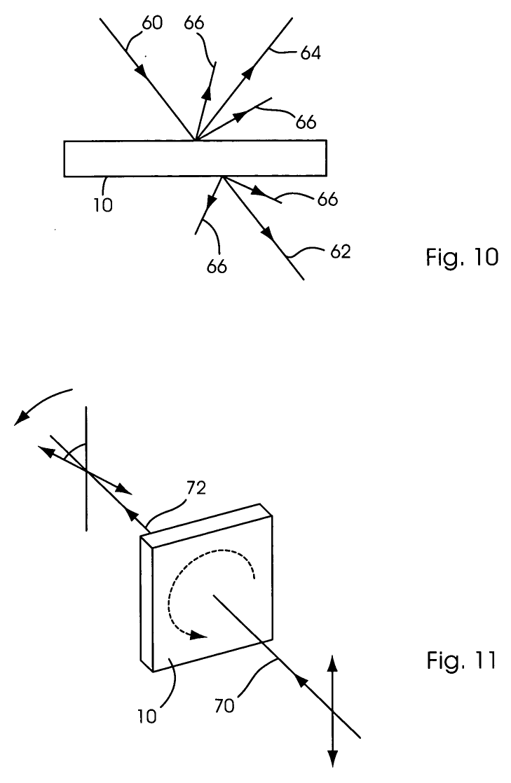

FIG. 10 is a diagrammatic representation of how an optical signal incident on the optical device of FIG. 1(a) will be processed into a transmitted optical signal, a reflected optical signal, or one or more diffracted optical signals;

FIG. 11 is a diagrammatic representation of how the polarisation of an optical signal incident on the optical device of FIG. 1(a) is changed on transmission through the device;

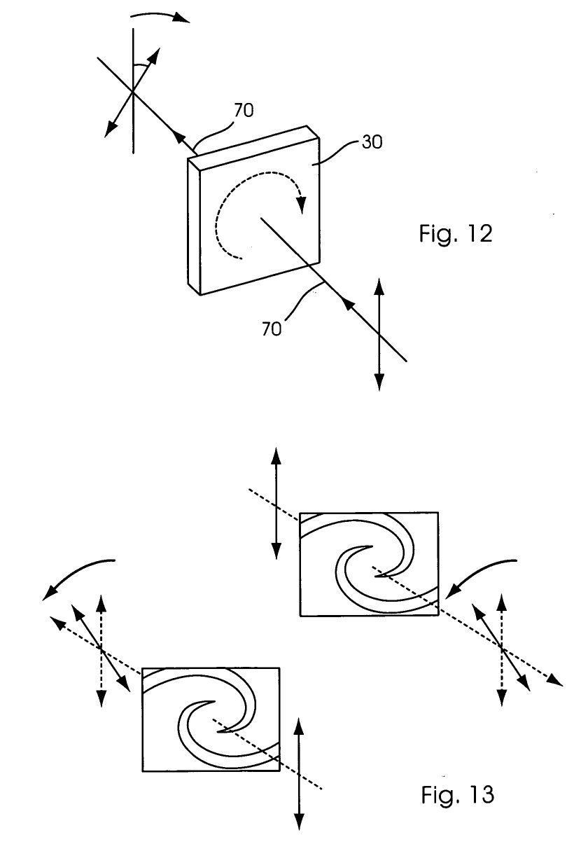

FIG. 12 is a diagrammatic representation of how the polarisation of an optical signal incident on the optical device of FIG. 1(b) is changed on transmission through the device;

FIG. 13 is a diagrammatic illustration of the principle of non-reciprocation shown in FIGS. 11 and 12;

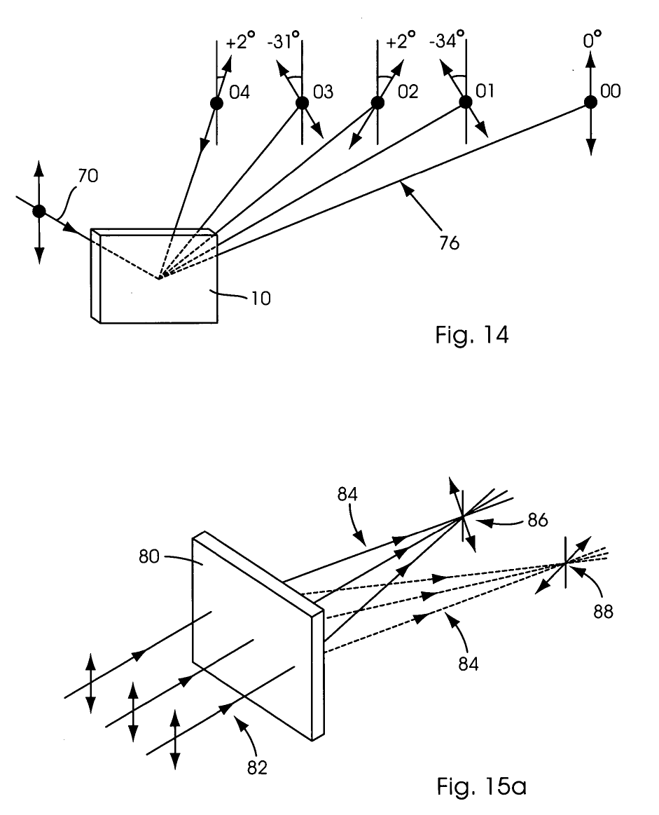

FIG. 14 is a diagrammatic illustration of how an incident optical signal is diffracted by the optical device of FIG. 1(a);

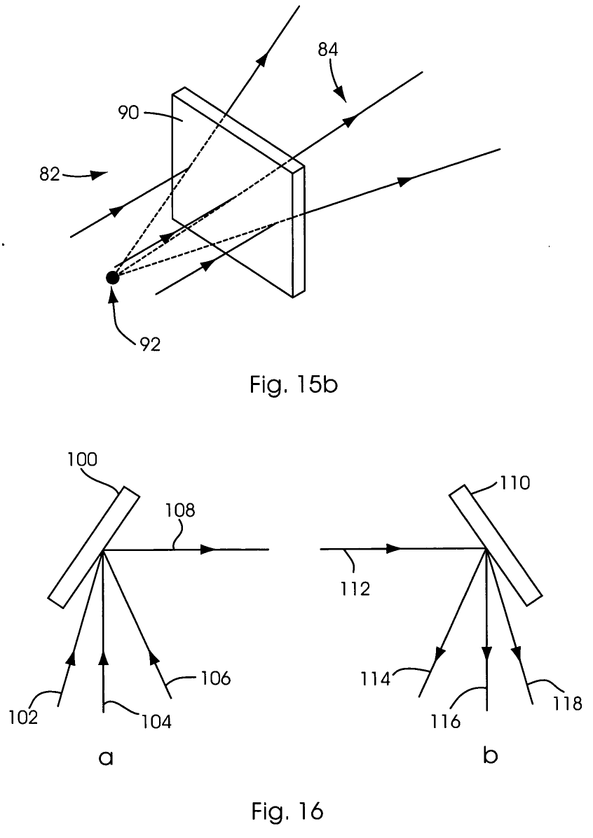

FIG. 15(a) is a diagrammatic representation of an optical device according to a ninth embodiment of the invention;

FIG. 15(b) is a diagrammatic representation of an optical device according to a tenth embodiment of the invention;

FIG. 16(a) is a diagrammatic representation of an optical device according to an eleventh embodiment of the invention;

FIG. 16(b) is a diagrammatic representation of an optical device according to a twelfth embodiment of the invention;

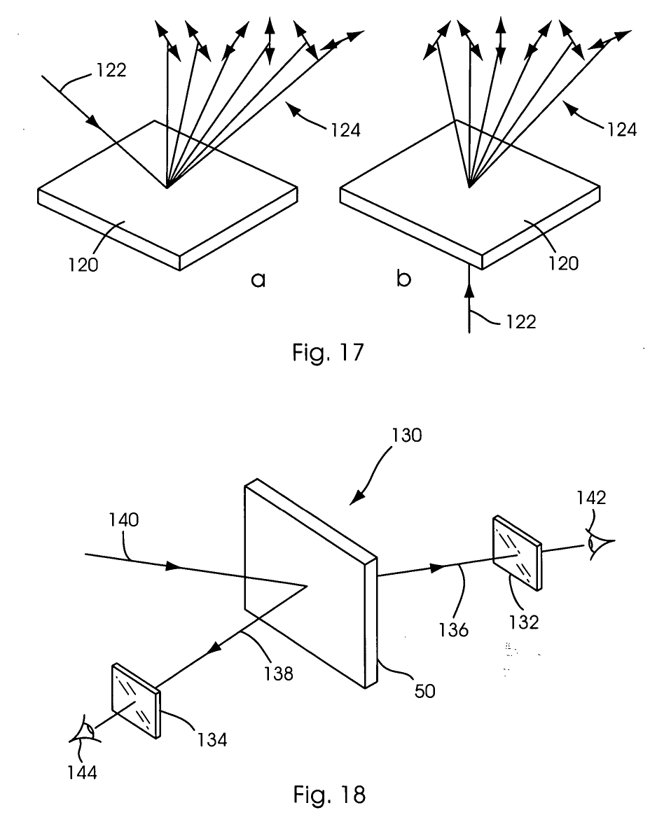

FIGS. 17(a) and (b) are diagrammatic representations of an optical device according to a thirteenth embodiment of the invention;

FIG. 18 is a diagrammatic representation of an optical device according to a fourteenth embodiment of the invention;

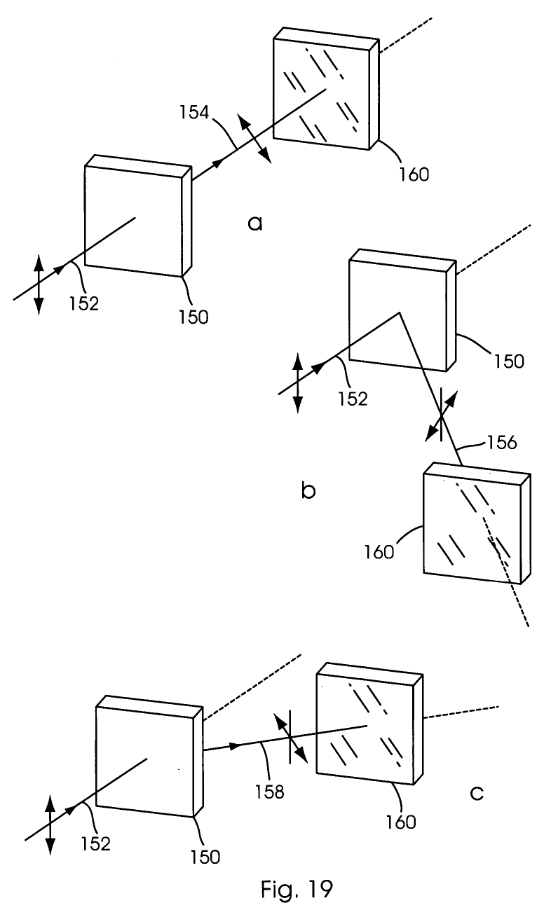

FIGS. 19(a), (b) and (c) are diagrammatic illustrations of how an optical device according to the present invention may be used as a polariser;

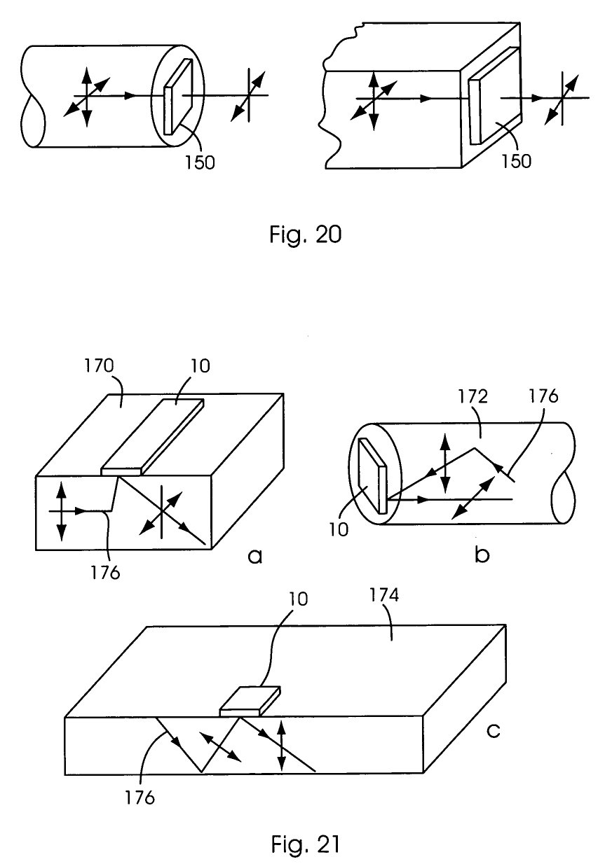

FIGS. 20(a) and (b) show the polariser of FIG. 19 located at the end of an optical fibre and an optical waveguide respectively;

FIGS. 21(a), (b) and (c) show the optical signal processing of FIG. 1(a) incorporated into an photonic bandgap crystal, located on a cleaved end of an optical fibre, and located on a planar optical structure respectively;

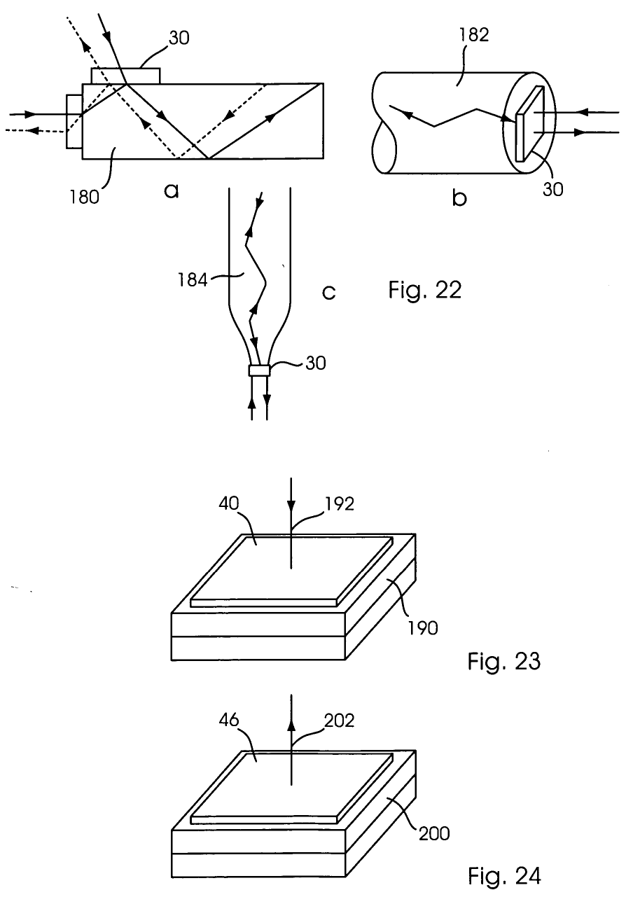

FIGS. 22(a), (b) and (c) show how an optical device according to the present invention, such as the device of FIG. 1(b), may further comprise an optical waveguide, an optical fibre or a near-field probe respectively, to couple and/or de-couple optical signals to and from the device;

FIG. 23 is a diagrammatic representation of the optical device of FIG. 5(a) optically coupled to a photodetector; and

FIG. 24 is a diagrammatic representation of the optical device of FIG. 5(c) optically coupled to a photoemitter.

An optical device 10 according to a first embodiment of the invention is shown in FIG. 1(a). The device 10 comprises a substantially planar first layer, which in this example is a layer of gold 14, supported by a silicon substrate layer 12, in the form of a silicon wafer 12. The gold layer 14 is formed with a pattern of solid shaped elements, in the form of (left-handed) gammadions. The gammadions have a size of between 700 nm and

4 μm. In this example the gammadions are arranged in a tiled regular square pattern. The device 10 has a pitch of

5 μm and an area of approximately

1.0×1.0 mm², with a density of gammadions of between

6×10⁵ cm⁻² and

6×10⁶ cm⁻². The device 10 was manufactured using a combination of direct-write electron beam lithography and either ion beam milling or a lift-off process, as will be discussed in more detail below. A planar object is said to be chiral if it cannot be brought into congruence with its mirror image unless it is lifted from the plane. There are two different hierarchical levels of planar chirality. The first is “molecular” chirality derived from the chirality of individual shaped elements which have no symmetry axes, such as gammadions of this example. “Molecular” chirality will survive even if the shaped elements are randomly orientated on the plane of the first layer 14. The second source of planar chirality is due to the ordering of the shaped elements themselves.

Two planar chiral objects of different chirality cannot be brought into congruence, unless they are lifted out of the plane by rotating by 180° about an axis within the plane of the structure. Examples of some planar chiral elements are shown in FIG. 2, where (a) is a gamma, (b) is a gammatta, (c) is a chiral split-ring, and (d) is a gammadion. Other planar chiral elements include anti-gammadions, S-shapes, spirals, and triskellas.

A quasi-planar chiral element in the form of a multi-layered element 20 is shown in FIG. 3. In this example the multi-layered element 20 has two layers 22, 24. As shown in FIG. 4, a piezoelectric layer 26 may be provided between the two layers 22, 24 of the bi-layered chiral element 20. By changing the thickness of the piezoelectric layer 26, by applying an appropriate electrical signal to it, the properties of the bi-layered element 20 can be altered, as discussed further below.

An optical device 30 according to a second embodiment of the invention is shown in FIG. 1(b). This device 30 is substantially the same as the device 10 according to the first embodiment, with the following modification. The same reference numerals are retained for corresponding features. In this example the shaped elements comprise right-handed gammadions (anti-gammadions).

FIG. 5(a) shows an optical device 40 according to a third embodiment of the invention. The same reference numerals are retained for corresponding features. The device 40 comprises a silicon substrate layer 12 supporting a layer of bi-layered chiral elements 20 fabricated in gold. In this example, the bi-layered chiral elements 20 are arranged in a chiral pattern, such that the pattern itself has chirality.

FIG. 5(b) shows an optical device 42 according to a fourth embodiment of the invention. The same reference numerals are retained for corresponding features. The device 42 comprises a silicon substrate layer 12 supporting a gold layer 14. The gold layer is formed with a pattern of shaped elements, in the form of right-handed gammas 44. The gammas 44 are arranged in a pattern that has planar chirality, each gamma 44 being rotated with respect to its neighbours.

FIG. 5(c) shows an optical device 46 according to a fifth embodiment of the invention. The device 46 of this embodiment is substantially the same as the device shown in FIG. 5(b), with the following modification. The same reference numerals are retained for corresponding features. In this example the gammas 44 are again arranged in a pattern that has planar chirality. Each gamma 44 is rotated with respect to its neighbours by a different angle to that shown in FIG. 5(b).

FIG. 5(d) shows an optical device 48 according to a sixth embodiment of the invention. The device 48 of this embodiment is substantially the same as the devices shown in FIGS. 5(b) and (c), with the following modifications. The same reference numerals are retained for corresponding features. In this example the pattern of gammas 44 has a smaller pitch and thus a higher density of gammas 44. In addition, the gammas 44 are rotated with respect to their neighbours by a different angle to that shown in FIGS. 5(b) and (c).

The shaped elements may be arranged in many different patterns having planar chirality. FIG. 6 shows three examples of tiled chiral patterns which may be used and FIG. 7 shows three examples of fractal chiral patterns which may be used.

An optical device 50 according to a seventh embodiment of the invention is shown in FIG. 8. The device 50 is substantially the same as the devices 10, 30, 40, 42, 46, 48 of the previous embodiments, with the following modifications. The same reference numerals are retained for corresponding features.

In this example the first layer 14 is provided with a pattern of non-chiral solid shaped elements, in the form of crosses having equal length arms. The crosses are arranged in a pattern which has planar chirality. This is an example of the second source of planar chirality where the chirality of the device 50 emerges as a result of the ordering of the shaped elements.

In this example, the crosses are arranged in a square grid, with each of the crosses being equally rotated by any angle, with respect to the grid, that is not a multiple of 45°. As a result, the pattern of crosses is chiral overall, and the structure will still have no axis of symmetry, even though neither the crosses nor the grid are themselves chiral. This type of planar “structural” chirality will, however, vanish if the non-chiral shaped elements are randomly oriented, with respect to the grid, within the plane of the first layer 14.

An optical device 60 according to an eighth embodiment of the invention is shown in FIG. 9. The device 60 is substantially the same as the devices 10, 30, 40, 42, 46, 48, 50 of the previous embodiments, with the following modifications. The same reference numerals are retained for corresponding features.

In this example a surrounding layer 62 is provided on top of the patterned first layer 14. The surrounding layer 62 covers the solid shaped elements of the patterned layer 14 and substantially fills the holes 64 in the first layer 14 between shaped elements. The material of the surrounding layer 62 may have structural chirality and it may contain carriers, such as plasmons, electrons, excitons or polaritons.

The operation of the optical devices provided by the present invention will now be described with reference to the devices 10, 30 of the first and second embodiments. However, it will be appreciated by a person skilled in the art that the devices 40, 42, 46, 48, 50, 60 according to the third to eighth embodiments of the could be used in their place.

Referring to FIG. 10, an optical signal 70 incident on the optical device 10 will be processed into a transmitted optical signal 72, a reflected optical signal 74, or one or more diffracted optical signals 76. The polarisation state and intensity of the transmitted 72, reflected 74 or diffracted optical signals 76 is dependent on the polarisation state, wavelength and intensity of the incident optical signal 70 and on the properties of the device 10, such as the size, pitch and density of the shaped elements, the properties of the materials, and the nature of the pattern formed by the shaped elements.

As shown in FIGS. 11 and 12, if the same optical signal 70 is incident on a first device 10 comprising shaped elements of a first chirality, in this example gammadions, and on a second device 30 comprising shaped element of the opposite chirality, in this example anti-gammadions, the polarisation state and the intensity of the optical signals 72 transmitted by the two devices 10, 30 will be different. That is to say, the devices 10, 30 act in a non-reciprocal manner. This is further illustrated in FIG. 13.

FIG. 14 shows in more detail how an incident optical signal 70 is diffracted by an optical device, such as the device 10 shown in FIG. 1(a). An optical beam 70 having a wavelength of 632 nm, and S or P polarisation, incident on the device at an angle of 60° is diffracted into a number of diffracted beams 76 forming a well-defined rectangular diffraction pattern. Only one row of diffracted beams 76 (in the plane of incidence) is shown for simplicity.

The polarisation states of the diffracted beams 76 are generally different from that of the incident beam 70: the 00 order diffracted beam maintains the same polarisation state; the polarisation azimuth of the 01 order diffracted beam is rotated by −34°; the polarisation azimuth of the 02 order diffracted beam is rotated by +2°; the polarisation azimuth of the 03 order diffracted beam is rotated by −31°; and the polarisation azimuth of the 04 order diffracted beam is rotated by +2°. In general the diffracted beams 76 become elliptically polarised and the polarisation azimuth rotates. It should be noted that for S and P incident polarisations no polarisation change is expected on reflection from an isotropic unstructured interface.

An important effect to note is that for a device comprising shaped elements of the opposite chirality, such as the device 30 of the second embodiment, the polarisation azimuth rotation was found to have opposite sign for equivalent diffraction orders.

FIG. 15(a) shows an optical device 80 according to a ninth embodiment of the invention. The device 80 is substantially the same as the device 10 according to the first embodiment of the invention, with the following modification. In this example the gammadions are arranged in a pattern which causes an incident optical signal 82 to be split into a plurality of diffracted beams 84, the diffracted beams 84 converging towards a focal point 86 or 88 in the far field. The location of the focal point 86, 88 is dependent on the polarisation state and/or wavelength of the incident optical signal 82, and the polarisation state, wavelength and intensity of the diffracted optical signals 84 are dependent on the properties of the device 80. The optical device 80 thereby acts as a polarisation state and/or wavelength sensitive optical signal concentrator or lens. When the gammadions are arranged in concentric rings the device 80 acts as a Fresnel lens.

An optical device 90 according to a tenth embodiment of the invention is shown in FIG. 15(b). The device 90 is substantially the same as the device 80 shown in FIG. 15(a), with the following modification. The same reference numerals are retained for corresponding features. In this example the gammadions are arranged in a pattern which causes the incident optical signal 82 to be split into a plurality of diffracted beams 84, the diffracted beams 84 diverging away from an effective focal point 92.

The devices 80, 90 shown in FIG. 15 may be modified such that the gammadions are arranged in a pattern containing one or more holograms, i.e. the normal diffraction pattern recorded as a hologram being replaced by the pattern of gammadions. In this case an incident optical signal 82 is split into a plurality of diffracted beams 84 which converge or diverge to form a hologrammatic image. The convergence or divergence of the diffracted beams 84 is dependent on the polarisation and/or wavelength of the incident optical signal, since this effects how the incident optical signal 82 interacts with the pattern of gammadions on the devices 80, 90. The devices 80, 90 can therefore be used to record more than one holographic image, with the desired image being displayed by illuminating the device 80, 90 with an optical signal of the appropriate wavelength and polarisation.

FIGS. 16(a) and (b) show an optical devices 100, 110 according to eleventh and twelfth embodiments of the invention respectively. The devices 100, 110 are substantially the same as the device 10 of the first embodiment, with the following modifications.

In the eleventh embodiment, the gammadions are arranged in a pattern which causes a plurality of incident optical signals (three are shown here) 102, 104, 106 to be multiplexed into a single outgoing optical signal 108. The device 100 thereby acts as an optical signal multiplexer, multiple optical signals of different wavelengths and/or polarisations being multiplexed into a single composite optical signal. In the twelfth embodiment, the gammadions are arranged in a pattern which causes an incident optical signal 112 to be demultiplexed (diffracted) into a plurality of output optical signal (three are shown here) 114, 116, 118. The device 110 thereby acts as an optical signal demultiplexer, a composite optical signal being split into a number of optical signal of different wavelengths and/or polarisations.

An optical device 120 according to a thirteenth embodiment of the invention is shown in FIGS. 17(a) and (b). The optical device 120 of this embodiment is substantially the same as the optical device 10 of the first embodiment, with the following modification. In this example the pattern in which the shaped elements (gammadions) are arranged contains information, such as a secret code, which is impressed onto an optical signal 122 when the optical signal 122 interacts with the device 120. The information is impressed on the optical signal 122 as polarisation and/or intensity modulation. The device 120 can work in reflection, as shown in FIG. 17(a) where an incident optical signal 122 is reflected and diffracted into a plurality (six in this example) of output beams 124. The device 120 can also work in transmission, as shown in FIG. 17(b) where an incident optical signal 122 is transmitted and diffracted into, in this example, six output beams 124.

FIG. 18 shows an optical device 130 according to a fourteenth embodiment of the invention. The device 130 is substantially the same as the optical device 50 of FIG.8, with the following modification. In this example the optical device further comprises polarising elements, such as polarising optical filters 132, 134, located in the optical path of a transmitted optical signal 136 and a reflected optical signal 138 respectively. For a linearly polarised input optical signal 140, the polarising filters 132, 134 will be circular polarisers. When an input optical signal 140 interacts with the optical device 50, the polarisation of the reflected optical signal 138 and the transmitted optical signal 136 is changed, as described above. When the transmitted optical signal 136 and the reflected optical signal 138 are observed (indicated by eyes 142,144) through their respective polarising elements 132, 134, the signal 136, 138 appear as different colours, since they have different polarisations.

The polarising elements 132, 134 may alternatively comprise a polarisation sensitive reflective microscope. Again, for a linearly polarised input optical signal 140 the reflective microscope will include a circular polariser. When viewed through the microscope the transmitted optical signal 136 and the reflected optical signal 134 each appear to have distinctly different colours when the chirality of the optical device 50 is changed, for example from right-handed to left-handed. The colour of the observed optical signal 134, 136 changes progressively as the chirality of the device changes progressively from left-handed to right-handed, or vice versa.

As shown in FIGS. 19(a), (b) and (c), by appropriate selection of the properties of an optical device 10, 30, 40, 42, 46, 48, 50, 60, 80, 90, such as the size of the shaped elements, the pitch of the shaped elements, and the material of the first layer, an optical device 10, 30, 40, 42, 46, 48, 50, 60, 80, 90, will function as a polariser 150. The polariser 150 acts to change the polarisation state of an incident optical signal 152 into a transmitted optical signal 154, a reflected optical signal 156, or a diffracted optical signal 158 of the correct polarisation for detection by a polarisation sensitive optical device 160. Many optical devices discriminate according to the polarisation state of an input optical signal and the optical device 150 can act on an optical signal before it reaches such an optical device 160, to set the polarisation of the optical signal to the correct polarisation for detection by the polarisation sensitive optical device 160. The optical device 150 thereby acts as a non-reciprocal wavelength sensitive and polarisation sensitive optical filter.

This non-reciprocal wavelength and polarisation sensitive optical device 150 can also be used as an optical isolator, to prevent unwanted back-transmission of optical signals within an optical communication line, or in front of a laser to prevent back-wards travelling optical signals reaching the laser cavity and disrupting the stability of the laser cavity. In these examples the optical device 150 may be provided on an end of an optical waveguide or fibre, as shown in FIG. 20(a) and (b) respectively.

As shown in FIG. 21(a), (b) and (c), an optical device as provided by the present invention, such as the device 10 shown in FIG. 1(a), may be incorporated into an photonic bandgap crystal 170, located on a cleaved end of an optical fibre 172, or located on a planar optical structure 174 respectively. The presence of the optical device 10 enables an optical signal 176 propagating within the photonic bandgap crystal 170, fibre 174 or planar structure 176 to be redirected to follow a different optical path and/or have its polarisation state changed on reflection from the optical device 10.

Referring to FIG. 22(a), (b) and (c) respectively, the optical devices 10, 30 (shown in FIG. 22), 40, 42, 46, 48, 50, 60, 80, 90, 100,110, 120, 130 150 provided by the present invention may further comprise an optical waveguide 180, an optical fibre 182 or a near-field probe 184 to couple and/or de-couple optical signals to and from the optical devices. The use of the waveguide 180, fibre 182 or near-field probe 184 enables the optical paths of the incident and/or output optical signals to be controlled, and can reduce losses within the optical devices.

As shown in FIG. 23, an optical device 10, 30,40 (shown in FIG. 23), 42, 46, 48, 50, 60, 80, 90 may be optically coupled to a photodetector 190 in order to select, by wavelength and/or polarisation, which components of an incident optical signal 192 are passed to the photodetector 190 for detection.

In a similar fashion, as shown in FIG. 24, an optical device 10, 30, 40, 42,46 (shown in FIG. 24), 48, 50, 60, 80, 90 may be optically coupled to a photoemitter 200, such as a light emitting diode or a super luminescent diode, in order to select, by wavelength and/or polarisation, which components of the optical signal generated by the photoemitter 200 are included within an output optical signal 202 to be transmitted to a subsequent optical system.

The optical devices 10, 30, 40, 42, 46, 48, 50, 60, 80, 90 described may be fabricated using one of several known manufacturing techniques, as follows.

Where the first layer is a metal, one suitable manufacturing process includes the following process steps:
a. deposition of a conducting metal layer directly onto the substrate layer;
b. deposition of a layer of photosensitive resin, polymer or resist onto the metal layer;
c. selective irradiation of part of the photosensitive resin, polymer or resist by the use of electromagnetic radiation or beams of ions or atoms or electrons;
d. removal of either the irradiated or the un-irradiated part of the photosensitive resin, polymer or resist layer by exposing all or part of the layer to a suitable chemical solvent that dissolves only the irradiated or the un-irradiated part of the photosensitive resin, polymer or resist layer to create layer of photosensitive resin, polymer or resist containing the desired pattern of shaped elements;
e. removal of the part of the metal layer left uncovered by the patterned layer of photosensitive resin, polymer or resist by use of a milling or etching process; and
f. removal of the remaining parts of the patterned layer of photosensitive resin, polymer or resist.

An alternative suitable manufacturing process for a metallic first layer includes the following process steps:
a. deposition of a layer of photosensitive resin, polymer or resist onto the substrate layer;
b. selective irradiation of part of the photosensitive resin, polymer or resist by the use of electromagnetic radiation or beams of ions or atoms or electrons;
c. removal of either the irradiated or the un-irradiated part of the photosensitive resin, polymer or resist layer by exposing all or part of the layer to a suitable chemical solvent that dissolves only the irradiated or the un-irradiated part of the photosensitive resin, polymer or resist layer to create a layer of photosensitive resin, polymer or resist containing the desired pattern of shaped elements;
d. deposition of a conducting metal layer directly onto the patterned layer of photosensitive resin, polymer or resist; and
e. removal of the metal on top of the remaining parts of the patterned layer of photosensitive resin, polymer or resist by the use of a ‘lift-off’ process where the metal on top of the patterned layer of photosensitive resin, polymer or resist is removed by dissolving the patterned layer of photosensitive resin, polymer or resist in a suitable chemical solvent, thereby causing the metal on top of it to diffuse away from the surface of the substrate layer.

Another suitable manufacturing process which may be used when the first layer is a metallic layer includes the following process steps:
a. deposition of a conducting metal layer directly onto the substrate layer;
b. deposition of a layer of photosensitive resin, polymer or resist onto the metal layer;
c. selective irradiation of part of the photosensitive resin, polymer or resist by the use of electromagnetic radiation or beams of ions or atoms or electrons;
d. removal of either the irradiated or the un-irradiated part of the photosensitive resin, polymer or resist layer by exposing all or part of the layer to a suitable chemical solvent that dissolves only the irradiated or the un-irradiated part of the photosensitive resin, polymer or resist layer to create layer of photosensitive resin, polymer or resist containing the desired pattern of shaped elements;
e. deposition by electroplating of additional conducting metal directly onto the parts of the metal layer not covered by the patterned layer of photosensitive resin, polymer or resist;
f. removal of the remaining parts of the patterned layer of photosensitive resin, polymer or resist; and
g. removal of the parts of the metallic layer left covered by the patterned layer of photosensitive resin, polymer or resist by use of a milling or etching process.

As discussed above, the first layer may alternatively comprise a layer of dielectric material. A suitable manufacturing process in this case includes the following process steps:
a. deposition of one or more layers of dielectric insulator directly onto the substrate layer;
b. deposition of a layer of photosensitive resin, polymer or resist onto the layer of dielectric material;
c. selective irradiation of part of the photosensitive resin, polymer or resist by the use of electromagnetic radiation or beams of ions or atoms or electrons;
d. removal of either the irradiated or the un-irradiated part of the photosensitive resin, polymer or resist layer by exposing all or part of the layer to a suitable chemical solvent that dissolves only the irradiated or the un-irradiated part of the photosensitive resin, polymer or resist layer to create a layer of photosensitive resin, polymer or resist containing a desired pattern of shaped elements;
e. removal of the part of the dielectric layer left uncovered by the patterned layer of photosensitive resin, polymer or resist by use of a milling or etching process; and
f. removal of the remaining parts of the patterned layer of photosensitive resin, polymer or resist.

The first layer may alternatively comprise a layer of a semiconductor material. A suitable manufacturing process for a semiconductor first layer includes the following process steps:
a. deposition of one or more layers of semiconductor directly onto the substrate layer;
b. deposition of a layer of photosensitive resin, polymer or resist onto the semiconductor layer;
c. selective irradiation of part of the photosensitive resin, polymer or resist by the use of electromagnetic radiation or beams of ions or atoms or electrons;
d. removal of either the irradiated or the un-irradiated part of the photosensitive resin, polymer or resist layer by exposing all or part of the layer to a suitable chemical solvent that dissolves only the irradiated or the un-irradiated part of the photosensitive resin, polymer or resist layer to create a layer of photosensitive resin, polymer or resist containing a desired pattern of shaped elements;
e. removal of the part of the semiconductor layer left uncovered by the patterned layer of photosensitive resin, polymer or resist by use of a milling or etching process; and
f. removal of the remaining parts of the patterned layer of photosensitive resin, polymer or resist.

An alternative manufacturing process which may be used when the first layer comprises a layer of a semiconductor material includes the following process steps:
a. deposition of one or more layers of dielectric insulator directly onto substrate layer;
b. deposition of a layer of photosensitive resin, polymer or resist onto the layer of deposited dielectric;
c. selective irradiation of part of the photosensitive resin, polymer or resist by the use of electromagnetic radiation or beams of ions or atoms or electrons;
d. removal of either the irradiated or the un-irradiated part of the photosensitive resin, polymer or resist layer by exposing all or part of the layer to a suitable chemical solvent that dissolves only the irradiated or the un-irradiated part of the photosensitive resin, polymer or resist layer to create a layer of photosensitive resin, polymer or resist containing a desired pattern of shaped elements;
e. removal of the part of the dielectric layer left uncovered by the patterned layer of photosensitive resin, polymer or resist by use of a milling or etching process;
f. removal of the remaining parts of the patterned layer of photosensitive resin, polymer or resist; and
g. selective deposition of one or more layers of semiconductor directly onto the parts of the substrate layer not covered by the patterned dielectric layer.

The deposition of the semiconductor material may be achieved using an epitaxial growth process. A suitable epitaxial growth processes which may be used include the following:
a. epitaxial growth of a doped or undoped semiconducting material onto a crystalline substrate or previously grown epitaxial layer of the same semiconductor material (homo-epitaxy), or of a different semiconductor material (hetero-epitaxy) to form a heterojunction;
b. epitaxial growth of a doped or undoped semiconducting material onto a crystalline substrate or previously grown epitaxial layer of the same material or different material, and of a different doping concentration or type;
c. epitaxial growth of a doped semiconducting material onto a crystalline substrate or previously grown epitaxial layer of the same material or different material, and of a different doping type to form a pn-junction;
d. epitaxial growth of layers of doped and undoped semiconducting material onto a crystalline substrate or previously grown epitaxial layer of the same material or different material, and of a different doping type to form a pin-junction;
e. selective epitaxial growth of an epitaxial semiconducting material with or without doping impurities onto a crystalline substrate or previously grown epitaxial layer of the same material (homo-epitaxy) and/or doping type or concentration, or of a different material (hetero-epitaxy) that has been masked with a patterned and where the epitaxial growth only occurs on the parts of the substrate where the masking layer is absent or has been removed prior to growth.

The irradiation of the photosensitive resin, polymer or resist layer may be performed by exposing the layer to either a beam of electromagnetic radiation having a wavelength of less than 8000 nm. The irradiation may alternatively be performed by bombardment of the photosensitive layer by a beam of ions or atoms or electrons. The beam of electromagnetic radiation, or ions or atoms or electrons, is focused onto the substrate layer to form a sharp point at the surface of the photosensitive resin, polymer or resist layer. The beam is deflected to different points on the surface of the photosensitive resin, polymer or resist layer to thereby expose selected areas of the photosensitive layer to the radiation, ions, atoms or electrons. Alternatively, a mask containing the desired pattern of shaped elements to be imprinted onto the photosensitive layer is placed in front of the photosensitive layer and the beam is incident on the surface of the photosensitive layer only where It has passed through a transparent region of the mask.

The manufacturing processes should also include the following cleaning stages:
1. as a first step the substrate layer undergoes at least one cleaning stage;
2. immediately prior to the deposition of a layer of photosensitive resin, polymer or resist the substrate layer undergoes at least one cleaning stage;
3. immediately prior to the deposition of a metal layer the substrate layer undergoes at least one cleaning stage;
4. immediately prior to the epitaxial growth of a semiconductor layer the substrate layer undergoes at least one cleaning stage; and
5. immediately prior to any etching the substrate layer undergoes at least one cleaning stage.

The cleaning stages may involve the use of acids, alkalis, organic solvents and/or oxidizing liquids. Alternatively, the cleaning stage may be performed using acetone (propanone), or isopropanol (propan-2-ol), or hydrofluoric acid, or nitric acid, or hydrochloric acid, or hydrogen peroxide, or sulphuric acid or ammonium peroxide, or any combination of acetone (propanone) and isopropanol (propan-2-ol) and hydrofluoric acid and nitric acid and hydrochloric acid and hydrogen peroxide and sulphuric acid and ammonium peroxide.

The cleaning stage may alternatively involve the use of ion beam bombardment of the surface being cleaned or the exposure of the surface being cleaned to ionic plasmas. The cleaning stage may alternatively involve the use of a plasma generated by the excitation of oxygen molecules using a radio frequency (R.F.) electromagnetic field.

The optical devices described above provide various advantages, as follows. The optical devices optically active in that they exhibit polarisation effects, thereby altering the polarisation state of an optical signal incident on a device. The devices also exhibit photonic bandgap anomalies in the visible and infra-red spectral regions. The optical devices mimic the behaviour of some molecules and liquid crystals and have been shown to perform as optically active artificial planar chiral molecules. The operational wavelength and the range of optical activity of the optical devices can be set by appropriate selection of the type of shaped elements formed in the first layer and the dimensions of both the shaped elements and the devices themselves. These parameters can be designed with lateral variations, thereby enabling tuning across a substrate. The optical effects can be seen in both reflection and transmission. Where the shaped elements comprise bi-layered structures, piezoelectric layers may be provided between the layers to thereby enable electro-optical control of the optical properties of the devices.

The optical devices may be used within a broad range of applications, including: stand alone optical components such as mirrors, beam splitters, diffraction gratings and filters; optical components in lasers and fibre optics; polarisation dependent semiconductor devices, including waveguides, waveguide and semiconductor lasers, optical amplifiers, and light emitting diodes; and wavelength and/or polarisation sensitive photodetector arrays and array spectrometers; optical rectifiers, valves and switches; and electro-optic modulators, particularly for use in polarimetry applications.

The optical devices offer additional functionality over many existing technologies. The optical devices represent a new class of metamaterials, which are easy to manufacture using modern micro-fabrication techniques. They promise new applications, since they manifest unique and intriguing properties, including different signs of polarisation rotation when illuminated from opposite sides of the device.

The described embodiments provide a planar chiral medium that consists of “flat” chiral elements or structure possessing no line of symmetry in the plane. The described embodiments provide new opportunities for manufacturing layered optical devices.

Various modifications may be made without departing from the scope of the present invention. For example, where the first layer is described as a metal layer a different metal may be described, or a semiconductor material or a dielectric material may be used in place of the metal. Any one or more of the materials used within the devices may themselves have structural chirality. Any one or more of the materials used within the devices may include carriers such as plasmons, electrons, excitons or polaritons, the affect of the collective excitation of the carriers enhancing the optical properties of the devices. Any one or more of the materials used within the devices may alternatively or additionally be a catalytic material, such that the devices can promote or inhibit chemical reactions for a given chiralty and/or actvaton energy.

The optical devices described may have a plurality of first layers formed with a pattern of shaped elements to thereby form a multi-layered structure.

Where the chiral shaped elements are described as gammadions, anti-gammadions may alternatively be used, and vice versa, or a different type of chiral element may be used in their place, such as a gamma, a gammatta, an S-shape, a spiral, a triskella, or a chiral split-ring. The shaped elements may alternatively be non-chiral shaped elements, such as crosses, with the pattern In which they are arranged having structural chirality. Where the shaped elements are described as being solid shaped elements formed in the first layer, they may alternatively comprise holes formed within the first layer. The holes may be filled with a dielectric material.

The pattern in which the chiral shaped elements are arranged may or may not have structural chirality. Where the pattern in which the shaped elements are arranged is described as being a regular or tiled pattern, an irregular or fractal pattern may alternatively be used.

The optical devices may additionally Include one or more tunnel junctions, such as Josephson, semiconductor, Schottky, or metal/oxide/semiconductor tunnel junctions within or between shaped elements, the presence of the tunnel junctions acting to enhance the optical properties of the optical devices.

Where the first layer comprises a semiconductor layer, openly transparent ohmic contacts of indium/tin oxide may be connected to one or more of the shaped elements.

1. An optical device comprising:
a substantially planar first layer of a first material, the first layer being formed with a pattern of one or more shaped elements,
each of the one or more shaped elements and/or the pattern having no line of symmetry within the plane of the layer,
such that an optical signal incident on the device is reflected and/or transmitted and/or diffracted by the device, and at least one of the polarisation state, intensity or phase of the optical signal is changed as a result of its interaction with the device.

2. A device as claimed in claim 1, wherein the device further comprises a substrate second layer of a second material having different electromagnetic properties to the first material, the substrate second layer supporting the layer of the first material.

3. A device as claimed in claim 1, wherein the first layer is formed with a pattern comprising a plurality of shaped elements.

4. A device as claimed in claim 1, wherein each of the one or more shaped elements is a chiral shaped element,

5. A device as claimed in claim 3, wherein the shaped elements are non-chiral shaped elements, the shaped elements being arranged in a pattern having planar chirality.

6. A device as claimed in claim 2, wherein the or each shaped element comprises either a solid shape formed in the substrate second layer, or a hole formed in the substrate second layer.

7. A device as claimed in claim 1, wherein the first layer comprises a layer selected from the group consisting of metal, semiconductor material, catalytic material, dielectric material, amorphous material, and glassy material.

8. A device as claimed in claim 1, wherein the first material s has a property selected from the group consisting of ferromagnetic, ferroelectric, piezoelectric, electro-optic, magneto-optic, photo-acoustic or electro-acoustic to thereby allow at least one of the polarisation state, intensity, phase or direction of the transmitted, reflected and/or diffracted light to be changed.

9. A device as claimed in claim 1, wherein the substrate second layer of comprises a crystalline material or a semiconductor material.

10. A device as claimed in claim 2, wherein the optical device further comprises a third layer selected from the group consisting of an electrically insulating material, a dielectric material, a piezoelectric material, a ferromagnetic material or a ferroelectric material, the third layer being provided between the substrate second layer and the first layer, or on top of the first layer.

11. A device as claimed in claim 1, wherein the optical device further comprises a layer of a surrounding material provided on top of the first layer, the surrounding layer extending into and substantially filling any holes present in the first layer.

12. A device as claimed in claim 11, wherein one or more of the first material, the second material, the material of the third layer or the surrounding material has planar chirality.

13. A device as claimed in claim 11, wherein one or more of the first material, the second material, the material of the third layer or the surrounding material contains particles, quasi-particles or excitations,

14. A device as claimed in claim 1, wherein the optical device further includes a tunnel junction, within a shaped element or between shaped elements.

15. A device as claimed in claim 1, wherein the device comprises a plurality of substantially planar layers with a pattern of one or more shaped elements.

16. (Cancelled)

17. A device as claimed in claim 4, wherein the chiral shaped element is selected from the group consisting of a gamma, a gammatta, a gammadion, an anti-gammadion, an S-shape, a spiral, a triskella, a chiral split-ring, and a bi-layered chiral shaped element.

18. A device as claimed in claim 5, wherein the non-chiral shaped elements comprise a cross having equal length arms.

19. A device as claimed in claim 13, wherein the particles, quasi-particles, or excitations are selected from the group consisting of plasmons, surface plasmon-polaritons, electrons, excitons and polaritons.

20. A device as claimed in claim 14, wherein the tunnel junction is selected from the group consisting of a Josephson tunnel junction, a semiconductor tunnel junction, a Schottky tunnel junction, and a metal/oxide/semiconductor tunnel junction.
